(19) United States
(12) Patent Application Publication
(10) Pub. No.: US 2024/0405671 A1
(43) Pub. Date: Dec. 5, 2024

(54) VOLTAGE CONVERTERS USING A SWITCH CAPACITOR VOLTAGE CONVERTER

(71) Applicant: Intel Corporation, Santa Clara, CA (US)

(72) Inventors: Chi-Hsiang HUANG, Seattle, WA (US); Su Hwan KIM, Portland, OR (US); Harish KRISHNAMURTHY, Beaverton, OR (US)

(21) Appl. No.: 18/203,553

(22) Filed: May 30, 2023

(51) Int. Cl. H02M 3/07

(52) U.S. Cl. CPC H02M 3/07

(57) ABSTRACT

Voltage converters using switch capacitor voltage converters are described. In some implementations, a hybrid converter having a switch capacitor voltage converter coupled with a downstream second voltage converter such as a buck regulator or LDO is described. It may incorporate circuitry for reducing output offset from the switch cap converter, which in turn, may reduce voltages exposed to switch transistors used in the downstream voltage regulator.

### BACKGROUND

A switch capacitor voltage converter may be used to step up or down an input DC voltage to a different output DC voltage. It can be used to efficiently transfer energy from one voltage supply to another without requiring many costly circuit components. However, as a result of parasitics and other non-ideal factors, it can generate excessive output voltage, which can be especially detrimental with some advanced integrated circuit applications.

### BRIEF DESCRIPTION OF DRAWINGS

Various examples in accordance with the present disclosure will be described with reference to the drawings, in which:

FIG. 1A is a circuit diagram showing a conventional switching capacitor type DC to DC converter (SCVC).

FIG. 1B is a signal diagram showing various signals for the switch capacitor voltage converter of FIG. 1A.

FIG. 2 is a generalized block diagram of a hybrid converter with a switch capacitor voltage converter in accordance with some embodiments.

FIG. 3 is a circuit diagram showing a hybrid converter with a switch capacitor converter implementing a PFM scheme in accordance with some embodiments.

FIG. 4 is a signal diagram showing various signals for the switch capacitor voltage converter within the hybrid converter of FIG. 3 in accordance with some embodiments.

FIG. 5 is a circuit diagram showing a hybrid converter with a switch capacitor converter having an auxiliary discharge path in accordance with some embodiments.

FIG. 6 is a circuit diagram showing a hybrid converter with a switch capacitor voltage converter employing frequency hopping in accordance with some embodiments.

FIG. 7 is a block diagram showing an example computing system employing one or more hybrid converters in accordance with some embodiments.

### DETAILED DESCRIPTION

In this disclosure, some techniques for reducing flying (or switch) capacitor offset in a switch capacitor voltage converter (SCVC) are presented. These techniques may be used alone or together in various combinations as may be desired depending upon specific design objectives. They may be used for switch capacitor converters used in any suitable scheme such as alone or as part of a hybrid converter using two or more separate converters coupled together. In some embodiments, a PFM (pulse frequency modulation) control approach may be used. With such a technique, a reference voltage may be used to regulate a switch capacitor output voltage in order to reduce the offset voltage across the flying capacitor. In some embodiments, an auxiliary path configured to bleed excess charge away from the flying capacitor may be employed. Such an auxiliary path may be used to divert charge from the flying capacitor into a load output to avoid an unnecessary waste of supply power. Another approach may be to employ discrete frequency hopping of the SCVC switching frequency, along with or without a small decoupling capacitor at its output, to improve the converter efficiency over varying load conditions and reduce its output voltage ripple.

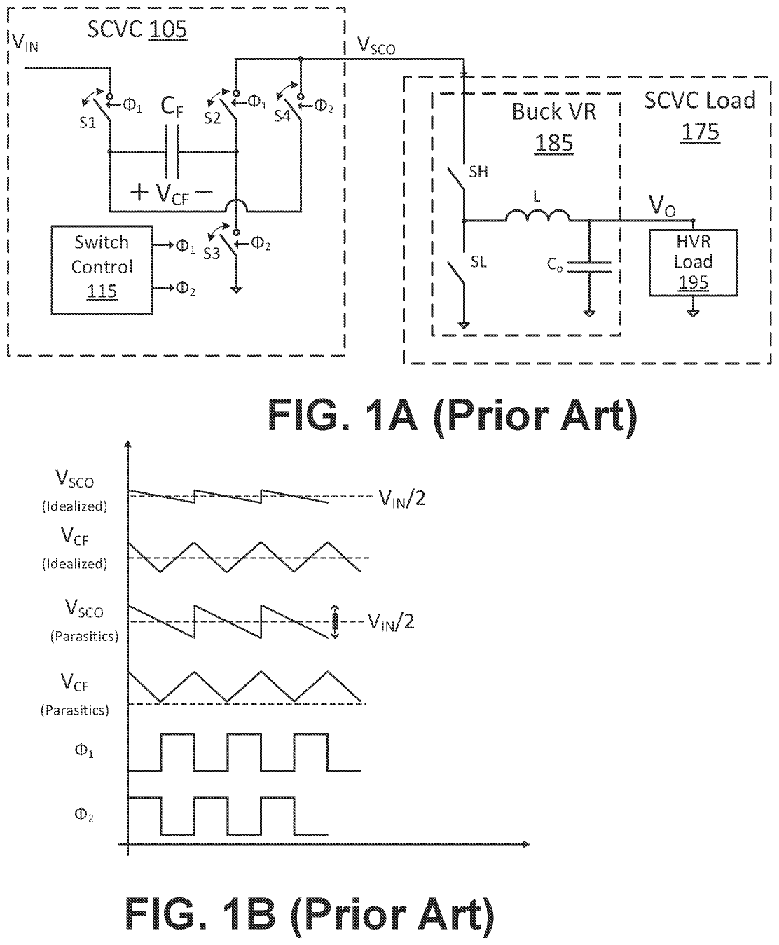

FIG. 1A shows a conventional switching capacitor type DC to DC converter (SCVC) 105 coupled to provide a stepped down output voltage (V_{SCO}) to a load 175. For example, as depicted, the load could be another voltage converter such as the depicted buck-type voltage regulator 185. When this is the case, the combination of SCVC 105 and voltage regulator (VR) 185 form a so-called hybrid converter having an input V_{IN} and output V_{O}.

With this example, the SCVC 105 is a 2:1 step-down DC-to-DC converter designed to generate its output (V_{SCO}) to be a DC supply voltage approximately equal to one-half the value of the input V_{IN}. SCVC 105 generally includes phase 1 switches S1, S2, phase 2 switches S3, S4, flying capacitor C_{F}, and switch control circuitry 115, coupled together as shown. The “flying” capacitor is termed, as such, because it is not fixed to any particular supply or ground references, but rather, is coupled to the supply and ground references through the phase switches, which allows it to transfer charge from the input to the output to provide the step-down output voltage (V_{SCO}).

With additional reference to FIG. 1B, the SCVC 105 operates in the two phases (Φ1, Φ2) each controlled using pulse signals with duty cycles approaching 50% (ideal) that are 180 degrees out of phase from one another. The switch control circuitry 115 generates these switch control signals. Under steady-state, ideal operation, the output voltage (V_{SCO}) will be half the input voltage (V_{IN}).

In operation, during the first phase, switches S1 and S2 are closed, and switches S3 and S4 are open, allowing current to flow from the input V_{IN}, across C_{F}, and into the output V_{SCO}. During the second phase, switches S1 and S2 are open, and switches S3 and S4 are closed. This grounds the low side of the flying capacitor and causes it to discharge into the load 175, resulting in the voltage across the load to be half of the input voltage. As shown in FIG. 1B, there is a steady-state ripple at the output voltage from capacitor charging and discharging operations, but the average voltage will be at half of the input voltage under ideal conditions. However, since the switches are normally implemented with transistors such as MOS transistors, which have associated parasitic capacitances, the voltage across the flying capacitor will be upwardly offset, which results in even wider ripple across the output V_{SCO}.

When the load 175 is a voltage regulator such as a buck-type switching regulator 185, the converters (105, 185) form a merged, two-stage hybrid regulator circuit. Such hybrid regulators are useful, especially when trying to step down a relatively wide voltage efficiently and over dynamic load conditions. The SCVC 105 steps down the input voltage (by one-half in the depiction) in a relatively efficient and cost-effective manner. From here, the VR 185 can work more efficiently, and reliably, working off of a lower input voltage (V_{SCO}) than it otherwise would see if V_{IN} was directly applied.

Unfortunately, it has been observed that with such hybrid converters, the average voltage across the flying capacitor plays an important role in determining voltage stress on the VR power devices (high and low side buck switches SH, SL). As mentioned above, when V_{F} is offset from its reasonably ideal value, it causes a larger voltage offset at the SCVC output (V_{SCO}), which serves as the input for VR 185. This, in turn can over-stress and potentially damage the power switches (SH, SL) and hurt the overall hybrid converter efficiency.

Some previous solutions have relied substantially on placing a decoupling capacitor at the SCVC output V_{SCO}. By doing so, the extra charges from parasitic capacitances in the phase 1,2 switches can be absorbed by the decoupling capacitor. Such solutions, however, can be difficult to implement due to trade-offs between efficiency and SCVC output ripple. Too large of a decoupling capacitor may make the converter lose the benefit of soft-charging, which degrades the converter efficiency, while too small of a capacitance can be ineffective in mitigating flying capacitor charge offset.

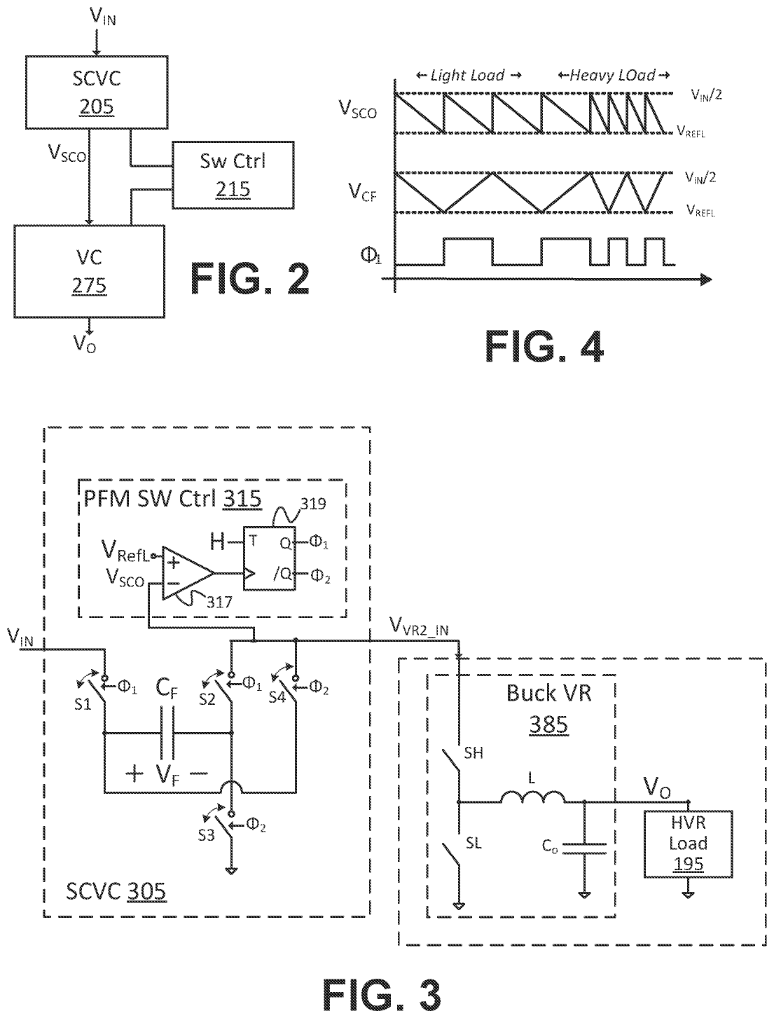

FIG. 2 is a generalized block diagram of a hybrid converter formed from a first switch capacitor voltage converter (SCVC) stage 205 and a second, downstream, voltage converter stage (VC 275) to generate an output supply voltage (V_{O}) from an input supply voltage (V_{IN}). The hybrid converter also includes a switch control unit 215 for controlling SCVC 205 to reduce flying (or switch) capacitor offset voltage and therefore reduce the voltage injected into the input of the second converter stage VC 275. (As used herein, the terms: “converter” and “regulator” have the following meanings. A voltage converter is a circuit that provides an output voltage from an input voltage where the output voltage is different from the input voltage. With a voltage converter, the output voltage may or may not be tightly regulated or even regulated at all. A voltage regulator is a voltage converter with a regulated output voltage. For example, it may operate, using closed-loop feedback, to maintain a reasonably constant output voltage over varying input supply and output load conditions.)

The SCVC 205 may be implemented with any suitable switching capacitor converter circuit topology. For example, it could be any type of switch capacitor converter to convert an input voltage (DC or sufficiently DC) to a different output voltage, either stepped up or down, although reducing output voltage offset may be more beneficial in a step-down application. It may use one or multiple flying capacitors, and it may convert the voltage by any desired ratio (e.g., 2:1, 3:1, 4:1, 3:2, 2:3, 1:2, etc.) with appropriate circuitry to effectuate the desired conversion ratio. A flying (or switch) capacitor may be contained in the same integrated circuit as the other parts of the SCVC, or it may be external therefrom. This will depend on the type and size of the utilized flying capacitor. Similarly, if the SCVC is used for relatively high power conversion, external or partially external phase switches may be employed.

Similarly, the second stage voltage converter 275 may be implemented with any suitable DC-to-DC voltage converter including step down or step-up converters or regulators. Moreover, it could be implemented with one or more converters, in parallel for a common load, in parallel to service different output loads, cascaded together in series, or in a combination of series and parallel multi-converter configurations. Similarly, different converter types could be used for these one or more VC converters. For example, switching buck, boost, coupled inductor converters, SCVCs, and linear converters such as low drop out (LDO) regulators could be used. As with the first stage converter, the second stage voltage converter may have components that are external to other of its components. For example, it may employ external inductors and/or capacitors. Likewise, the converters may share control circuitry, be controlled in harmony with one another or may operate fairly independently from one another. In some embodiments, the SCVC phase switching will be independent from and likely lower than that of the second stage switches when switching type VCs are used for the second stage converter.

The switch control unit (or circuit) 215, among other things, may control switching of the SCVC 205 with discharge control circuitry to reduce SCVC output voltage offset. It may implement PFM, auxiliary discharge, frequency hopping, or combinations thereof. It may include circuitry for starting up capacitor switching and circuitry for controlling capacitor switching once in a steady-state operational mode. It could be implemented with discrete circuit components, a finite state machine (FSM), a controller controlled with software, or combinations of any of these, or other-type, circuit implementations.

FIG. 3 is a circuit diagram showing a hybrid converter implementing a PFM scheme for reducing switch capacitor output voltage offset. The hybrid converter includes a first converter stage, SCVC 305, coupled to a second stage converter, VR 385 to generate a regulated output voltage V_{O} off of a supplied input voltage V_{IN}. The SCVC 305 includes phase 1 switches (S1, S2), phase 2 switches (S3, S4), switch (or flying) capacitor C_{F}, and switch control circuitry 315, which includes discharge control circuitry (PFM switch control in this embodiment). (Note that in this depiction, the switch control circuit 315 is shown within the SCVC for convenience, but circuitry for implementing switch control functionality may be thought of as outside of, within, or both within and outside of the SCVC or even the hybrid converter for that matter.)

The switch control circuit 315 includes a comparator 317 and a toggle-type flip-flop 319 coupled as shown between the SCVC output (V_{SCO}) and switch control inputs (Φ1, Φ2). Comparator 317 has an inverting input coupled to the SCVC output and a non-inverting input coupled to a “low” reference level voltage V_{REFL}. (It is referred to as “low” because it is lower than the target SCVC output V_{SCO}, which in the figure is V_{IN}/2. In this embodiment, the toggle flip-flop 319 is edge-triggered off of a Low to High clock input transition. So, when V_{SCO} goes below V_{REFL}, comparator 317 outputs a high, resulting in a low-to-high transition at the clock input causing the flip-flop outputs to toggle. Since the outputs control the phase 1 and phase 2 switches, this also causes the switches to change, resulting in a PFM operational control as is depicted in the signal diagram of FIG. 4.

V_{REFL} is used as a low-bounded threshold. When V_{SCO} falls below V_{REFL}, the SCVC switches from one phase to the other. When the phases switch, in either direction (e.g., phase 1 going low to high or high to low), V_{SCO} will immediately go higher, which effectively “resets” the flop by causing the comparator output to return back to low. The switch control circuitry 315 may include circuitry (not shown) for SCVC activation, but once the converter enters PFM control, steady-state operation may be maintained, and the offset of the flying capacitor will be automatically reduced, making the offset at V_{SCO} also smaller. As indicated in FIG. 4, this also results in more efficient converter operation with the SCVC switching frequency automatically increasing for higher loads and decreasing for smaller loads.

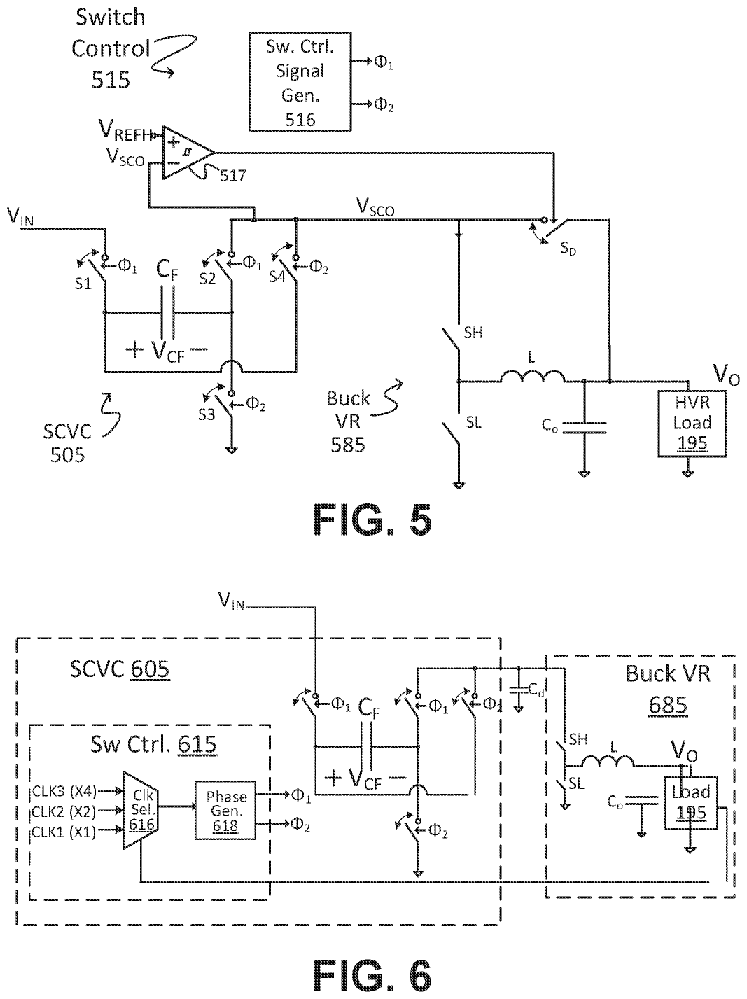

FIG. 5 shows an embodiment of a hybrid converter with an auxiliary path to discharge the flying capacitor. The hybrid converter includes SCVC 505, Buck VR 585, and switch and discharge control circuit 515, coupled as shown to provide an output supply voltage V_{O} to HVR load 195 generated from input voltage V_{IN}.

The switch control circuit 515, among other things, includes a switch control signal generator circuit 516 to generate the phase switch control clocks, a comparator 517 (e.g., hysteretic comparator), and discharge switch S_{D}, which is coupled between V_{SCO} and the load output V_{O} to discharge current therefrom in order to reduce the SCVC output (V_{SCO}) supply offset. Hysteretic comparator 517 has an inverting input coupled to V_{SCO}, a non-inverting input coupled to a high bounded voltage reference (V_{REFH}), and an output coupled to discharge switch S_{D} to control whether it is open or closed.

In operation, the comparator and discharge switch function to maintain the SCVC output (V_{SCO}) below a threshold (e.g., hysteretic threshold defined by the comparator's hysteretic configuration) and the high threshold reference (V_{REFH}). When V_{SCO} goes above this threshold, discharge switch S_{D} closes, and charge is diverted away from the SCVC output. IN the depicted embodiment, the diverted charge is passed through to the output load 195 so as to avoid wasting the energy. However, it alternatively could simply be flushed to ground or to some other suitable sink.

Since the highest output voltage (V_{SCO}) generally occurs when the Φ2 switches turn on (in this embodiment), the auxiliary switch S_{D} will invariably close upon this transition and open when V_{SCO} goes sufficiently below the threshold level. With this in mind, in some alternative embodiments, rather than using a high level threshold detection approach, a simpler scheme could be employed based off of the known phase switch transition that causes the highest SCVC output voltage. For example, the transition to this phase could trigger a one-shot, or another suitable time-limited pulse generation circuit, to turn on the discharge switch for a time frame within the “high-level” phase on-time (in this case, within phase 2 on time). Along these lines, the discharge switch S_{D} may be implemented in any suitable manner. For example, one or more transistors or other circuit switch components could be used, and it may be configured to also be at least somewhat controlled, directly or indirectly, by the second stage converter to direct the discharge current appropriately, e.g., into the load when needed.

FIG. 6 shows another hybrid converter embodiment with SCVC offset mitigation. For applications that do not allow, or would not be suited for, variable frequency operation, as with PFM control, a frequency hopping approach, such as that shown in FIG. 6, may be employed. With this embodiment, a switch control unit 615 having frequency hopping circuitry is used. The hybrid converter may also include a relatively small decoupling capacitor (C_{D}) placed, as shown, at the SCVC output (V_{SCO}).

The switch control unit 615 includes clock selection module 616 and phase signal generation module 618, coupled as shown. The clock selection module 616 is coupled to the VR output to monitor current for load 195 in order to select and provide a corresponding clock option to the phase signal generation module 618. In the depicted embodiment, three clock frequency options are available to the clock selection module 616. They include multiples of the lowest frequency option, X1, X2, and X4. For example, in an implementation, the X1 option has a clock frequency of 6.25 MHZ, the X2 option has a frequency of 12.5 MHZ, and the X4 option has a frequency of 25 MHz. The clock selection module chooses the particular clock option based on the load current. Lower currents result in a lower frequency selection, while higher currents result in a higher frequency selection. The clocks may be designed to be within a predefined range to allow for suitable filtering such as for EMI (electro magnetic interference) mitigation.

The phase signal generation module 618 generates suitable phase 1 and phase 2 clocked pulses off of the selected clock from the selection module 616. For example, it could generate complementary phase clocks each having duty cycles of, or approaching 50%. The phase generation module may also include non-overlapping circuitry to prevent the phases from being on at the same time. Such circuitry may also be included in the afore described hybrid converter embodiments, although it may be more important in a frequency hopping scheme having dynamically changing source clocks.

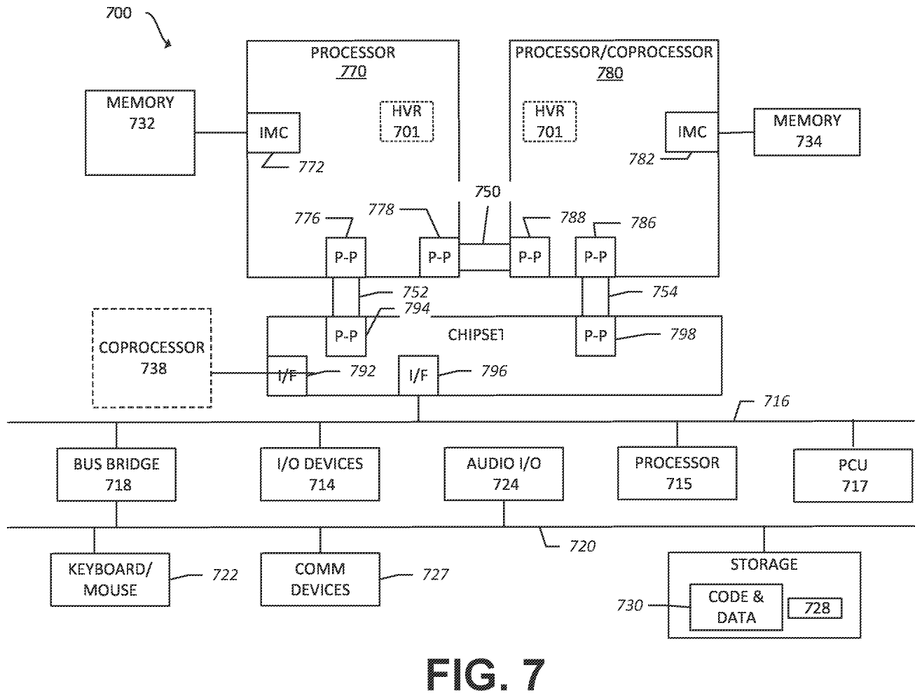

FIG. 7 illustrates an example computing system 700. Processor system 700, which may be a single or multi processor system, is an interfaced system and includes one or more processors including a first processor 770 and in some embodiments, a second processor 780 coupled via an interface 750 such as a point-to-point (P-P) interconnect, a fabric, and/or bus. In some examples, the first processor 770 and/or the second processor 780 are homogeneous. In some examples, first processor 770 and/or the second processor 780 are heterogenous. Though the example system 700 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 770 and 780 are shown including integrated memory controller (IMC) circuitry 772 and 782, respectively. Processor 770 also includes interface circuits 776 and 778, along with core sets. Similarly, second processor 780 includes interface circuits 786 and 788, along with a core set as well. Pertinent to this disclosure, they also may include one or more HVRs 701 as described herein. For example, an HVR may be used to provide to one or more power domains in the processor(s) a stepped down supply voltage from a higher, off-chip power supply. The HVR circuitry may be contained within the same processor package or alternatively, some components, such as the switch capacitors and VR inductors, may be mounted outside of the die or dies containing the rest of the HVR circuitry.

A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines. In some embodiments, one or more HVRs 701 with buck-type regulators as second stage converters may be used to provide to the processor(s) a stepped down supply voltage from an off-chip supply source. In turn, HVRs with buck type or LDO second stage converters may be used within the processor(s) to supply tailored voltage supplies or supply ranges to different power domains within a chip.

Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect, or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to one or more voltage regulators (any of which may be implemented with an HVR in accordance with this disclosure) to cause the voltage regulator(s) to generate the appropriate regulated voltage(s). PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. For example, with some mobile, client, and/or server platform implementations, one or more PMICs may include one or more HVRs in accordance with this disclosure to supply power to components in the mobile, client, and/or server platform.

In yet other examples, power management operations to be performed by PCU 717 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage in some examples. Further, an audio I/O 724 may be coupled to second interface 720. Note that other architectures than the point-to-point architecture described above are possible. For example, instead of the point-to-point architecture, a system such as system 700 may implement a multi-drop interface or other such architecture.

Illustrative examples of the technologies disclosed herein are provided below. An embodiment of the technologies may include any one or more, and any compatible combination of, the examples described below.

Example 1 is an apparatus, that comprises a switch capacitor (SC) converter circuit having an input to receive an input voltage, an SC output to provide an SC output voltage, and nodes to couple a flying capacitor to be switchably coupled between the input and SC output to transfer charge to the SC output to provide the SC output voltage. The apparatus also includes switch control circuitry including discharge control circuitry coupled to the SC output to discharge the flying capacitor in response to the SC output voltage reaching a reference voltage level.

Example 2 includes the subject matter of Example 1, and wherein the discharge control circuitry includes a comparator having a first input coupled to the SC output and a second input to receive the reference voltage level.

Example 3 includes the subject matter of any of Examples 1-2, and wherein the comparator is a hysteretic comparator.

Example 4 includes the subject matter of any of Examples 1-2, and wherein the discharge control circuitry includes a toggle circuit coupled to the comparator to control first and second phase switches of the SC converter, wherein the phase switches are to flip in response to the SC output voltage reaching the reference voltage from a first direction.

Example 5 includes the subject matter of any of Examples 1-4, and wherein the phase switches are to flip in response to the SC output voltage going below the reference voltage.

Example 6 includes the subject matter of any of Examples 1-5, and wherein the toggle circuit includes an edge-triggered toggle flip-flop circuit.

Example 7 includes the subject matter of any of Examples 1-6, and wherein the phase switches are implemented with field effect transistors.

Example 8 includes the subject matter of any of Examples 1-7, and wherein the SC output discharge circuitry includes an auxiliary discharge switch coupled to an output of the comparator to discharge current from the SC output into a load in response to the SC output voltage going above the reference voltage level.

Example 9 includes the subject matter of any of Examples 1-8, and wherein the comparator is a hysteretic comparator.

Example 10 includes the subject matter of any of Examples 1-9, and wherein the load includes a voltage regulator coupled between the SC output and a VR load to provide a regulated output voltage to the VR load, the auxiliary discharge switch being coupled between the SC output and the voltage regulator to discharge current into the VR load.

Example 11 includes the subject matter of any of Examples 1-10, and, wherein the voltage regulator is a buck-type switching regulator.

Example 12 is an apparatus that comprises a voltage regulator circuit having an input coupled to a switch capacitor voltage converter (SCVC) output (SC output) to receive an SC output voltage from an SCVC that includes first phase switches and second phase switches. It also includes a switch control circuitry to control the first and second phase switches and discharge control circuitry to limit the SC output voltage.

Example 13 includes the subject matter of Example 12, and wherein the switch control circuitry is to control the first and second phase switches with pulse control signals selected from one of two or more discrete frequency options, the selected frequency option being based on monitored current from an output of the voltage regulator.

Example 14 includes the subject matter of any of Examples 12-13, and wherein the two or more discrete frequency options are integer multiples of a lowest frequency option.

Example 15 includes the subject matter of any of Examples 12-14, and also includes a discharge switch coupled between the voltage regulator and the SC output to discharge current from the SC output into the voltage regulator.

Example 16 includes the subject matter of any of Examples 12-15, and wherein the discharge switch is to discharge current from the SC output into the voltage regulator output, the discharge switch being in parallel with the voltage regulator.

Example 17 includes the subject matter of any of Examples 12-16, and wherein the discharge circuitry is to bleed charge from the SC output in response to the SC output voltage reaching a reference voltage level.

Example 18 includes the subject matter of any of Examples 12-17, and wherein the SC output discharge circuitry includes a comparator having a first input coupled to the SC output and a second input to receive the reference voltage level.

Example 19 includes the subject matter of any of Examples 12-18, and wherein the comparator is a hysteretic comparator and the reference voltage level is not fixed.

Example 20 includes the subject matter of any of Examples 12-19, and wherein the SC output discharge circuitry includes a toggle circuit coupled to the comparator to control the first and second phase switches, wherein the phase switches are to flip in response to the SC output voltage reaching the reference voltage from a first direction.

Example 21 includes the subject matter of any of Examples 12-20, and wherein the phase switches are to flip in response to the SC output voltage going below the reference voltage.

Example 22 includes the subject matter of any of Examples 12-21, and wherein the toggle circuit includes an edge-triggered toggle flip-flop circuit.

Example 23 includes the subject matter of any of Examples 12-22, and wherein the phase switches are implemented with FinFET or GAA transistors.

Example 24 includes the subject matter of any of Examples 12-23, and wherein the discharge control circuitry includes an auxiliary discharge switch coupled between the SC output and an output of the voltage regulator to discharge current from the SC output into a load at the voltage regulator output in response to the SC output voltage going above a reference voltage level.

Example 25 includes the subject matter of any of Examples 12-24, and wherein the discharge control circuit includes a hysteretic comparator to control the auxiliary discharge switch, wherein the reference voltage level is not fixed.

Example 26 is a system that comprises a processor formed from one or more processor chips coupled to one another and having a plurality of power domains. It also includes a hybrid step-down DC-DC converter to provide power to the processor, wherein the hybrid converter includes a switch capacitor (SC) voltage converter including an input to receive an input voltage, an SC output to provide a stepped-down SC output voltage from the input voltage, and first phase switches and second phase switches to control a flying capacitor to generate the SC output voltage. The system further includes a voltage regulator circuit having an input coupled to the SC output and a VR output to provide a regulated output voltage to the processor. It also includes a switch control circuitry including discharge control circuitry coupled to the SC converter to discharge the flying capacitor in response to the SC output voltage reaching a reference voltage level.

Example 27 includes the subject matter of Example 26, and wherein the discharge control circuitry includes a comparator having a first input coupled to the SC output and a second input to receive the reference voltage level.

Example 28 includes the subject matter of any of Examples 26-27, and wherein the comparator is a hysteretic comparator.

Example 29 includes the subject matter of any of Examples 26-28, and wherein the discharge control circuitry includes a toggle circuit coupled to the comparator to control first and second phase switch circuits of the SC converter, wherein the phase switches are to flip in response to the SC output voltage reaching the reference voltage from a first direction.

Example 30 includes the subject matter of any of Examples 26-29, and wherein the phase switches are to flip in response to the SC output voltage going below the reference voltage.

Example 31 includes the subject matter of any of Examples 26-30, and wherein the toggle circuit includes an edge-triggered toggle flip-flop circuit.

Example 32 includes the subject matter of any of Examples 26-31, and wherein the phase switches are implemented with FinFET or GAA transistors.

Example 33 includes the subject matter of any of Examples 26-32, and wherein the discharge control circuitry includes an auxiliary discharge switch coupled to an output of the comparator to discharge current from the SC output into a load in response to the SC output voltage going above the reference voltage level.

Example 34 includes the subject matter of any of Examples 26-33, and wherein the comparator is a hysteretic comparator.

Example 35 includes the subject matter of any of Examples 26-34, and wherein the flying capacitor includes one or more capacitors not integrated within the one ore more processor chips.

Example 36 includes the subject matter of any of Examples 26-35, and wherein the voltage regulator is a buck-type regulator.

Example 37 includes the subject matter of any of Examples 26-36, and wherein the voltage regulator is a linear voltage regulator.

Example 38 includes the subject matter of any of Examples 26-37, and wherein the voltage regulator comprises multiple linear regulators coupled in parallel with each other off of the SC voltage converter.

Example 39 is a hybrid regulator circuit that comprises a step-down switch capacitor (SC) converter circuit having an SC input, and SC output, and nodes to couple to a flying capacitor between the SC input and SC output through first phase switches and second phase switches. The hybrid converter also includes a voltage regulator circuit having a VR input coupled to the SC output and a VR output to be coupled to a load having a load current when operationally coupled to the VR output. The hybrid converter further includes a switch control circuitry including pulse generator circuitry to control the first and second phase switches with pulse control signals selected from one of two or more discrete frequency options, the selected frequency option being based on the load current.

Example 40 includes the subject matter of Example 39, and wherein the two or more discrete frequency options are integer multiples of a lowest frequency option.

Example 41 includes the subject matter of any of Examples 39-40, and further comprises a discharge switch coupled between the load and the SC output to discharge current from the SC output into the load, the discharge switch being in parallel with the voltage regulator.

Example 42 is a processor that includes a hybrid regulator in accordance with any of examples 39-41, and wherein the voltage regulator is to provide power to one or more power domains of the processor.

Example 43 is a processor that includes a hybrid regulator in accordance with any of examples 39-42, and wherein the voltage regulator is a buck type regulator.

Example 44 is a processor that includes a hybrid regulator in accordance with any of examples 39-42, and wherein the voltage regulator is a low drop out regulator.

Example 45 is an apparatus that comprises a hybrid voltage converter including a switch capacitor first stage coupled to a voltage regulator second stage to provide the voltage regulator with a stepped down SC output voltage. It also includes discharge means for inhibiting the SC output voltage when the SC output voltage exceeds a threshold.

Example 46 is an apparatus that includes example 45, and wherein the discharge means is to control the SC voltage converter to operate in a pulse frequency modulation (PFM) mode.

Example 47 is an apparatus that includes any of examples 45-46, and wherein the discharge means is to bleed charge out of the SC voltage converter through a discharge switch.

Example 48 is an apparatus that includes any of examples 45-47, and wherein the discharge means is to employ a frequency hopping method to change capacitor switching frequency based on load current out of the voltage regulator.

Example 49 is an apparatus that includes any of examples 45-48, and wherein the voltage regulator is a buck type voltage regulator.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. Different circuits or modules may share or even consist of common components. for example, A controller circuit may be a circuit to perform a first function and at the same time, the same controller circuit may also be a circuit to perform another function, related or not related to the first function.

The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors (BJT PNP/NPN), BiCMOS, CMOS, GaN, etc., may be used without departing from the scope of the disclosure.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus, comprising:
a switch capacitor (SC) converter circuit having an input to receive an input voltage, an SC output to provide an SC output voltage, and nodes to couple a flying capacitor to be switchably coupled between the input and SC output to transfer charge to the SC output to provide the SC output voltage; and
switch control circuitry including discharge control circuitry coupled to the SC output to discharge the flying capacitor in response to the SC output voltage reaching a reference voltage level.

2. The apparatus of claim 1, wherein the discharge control circuitry includes a comparator having a first input coupled to the SC output and a second input to receive the reference voltage level.

3. The apparatus of claim 2, wherein the comparator is a hysteretic comparator.

4. The apparatus of claim 2, wherein the discharge control circuitry includes a toggle circuit coupled to the comparator to control first and second phase switches of the SC converter, wherein the phase switches are to flip in response to the SC output voltage reaching the reference voltage from a first direction.

5. The apparatus of claim 4, wherein the phase switches are to flip in response to the SC output voltage going below the reference voltage.

6. The apparatus of claim 4, wherein the toggle circuit includes an edge-triggered toggle flip-flop circuit.

7. A system having a processor and a hybrid converter to provide power to the processor, the hybrid converter including a switch capacitor converter in accordance with the apparatus of claim 2.

8. The apparatus of claim 2, wherein the SC output discharge circuitry includes an auxiliary discharge switch coupled to an output of the comparator to discharge current from the SC output into a load in response to the SC output voltage going above the reference voltage level.

9. The apparatus of claim 8, wherein the load includes a voltage regulator coupled between the SC output and a VR load to provide a regulated output voltage to the VR load, the auxiliary discharge switch being coupled between the SC output and the voltage regulator to discharge current into the VR load.

10. The apparatus of claim 9, wherein the voltage regulator is a buck-type switching regulator.

11. An apparatus, comprising:
a voltage regulator circuit having an input coupled to a switch capacitor voltage converter (SCVC) output (SC output) to receive an SC output voltage from an SCVC that includes first phase switches and second phase switches; and
switch control circuitry to control the first and second phase switches and including discharge control circuitry to limit the SC output voltage.

12. The apparatus of claim 11, wherein the switch control circuitry is to control the first and second phase switches with pulse control signals selected from one of two or more discrete frequency options, the selected frequency option being based on monitored current from an output of the voltage regulator.

13. The apparatus of claim 11, comprising a discharge switch coupled between the voltage regulator and the SC output to discharge current from the SC output into the voltage regulator.

14. An integrated circuit module including a processor and a voltage regulator circuit in accordance with the voltage regulator circuit of claim 11.

15. The apparatus of claim 11, wherein the discharge circuitry is to bleed charge from the SC output in response to the SC output voltage reaching a reference voltage level.

16. An apparatus, comprising:
a processor formed from one or more processor chips coupled to one another and having a plurality of power domains; and
a hybrid step-down DC-DC converter to provide power to the processor, the hybrid converter including:
a switch capacitor (SC) voltage converter including an input to receive an input voltage, an SC output to provide a stepped-down SC output voltage from the input voltage, and first phase switches and second phase switches to control a flying capacitor to generate the SC output voltage;
a voltage regulator circuit having an input coupled to the SC output and a VR output to provide a regulated output voltage to the processor; and
switch control circuitry including discharge control circuitry coupled to the SC converter to discharge the flying capacitor in response to the SC output voltage reaching a reference voltage level.

17. The apparatus of claim 16, wherein the discharge control circuitry includes a comparator having a first input coupled to the SC output and a second input to receive the reference voltage level.

18. The apparatus of claim 17, wherein the discharge control circuitry includes a toggle circuit coupled to the comparator to control first and second phase switch circuits of the SC converter, wherein the phase switches are to flip in response to the SC output voltage reaching the reference voltage from a first direction.

19. The apparatus of claim 18, wherein the phase switches are to flip in response to the SC output voltage going below the reference voltage.

20. The apparatus of claim 16, wherein the discharge control circuitry includes an auxiliary discharge switch coupled to an output of the comparator to discharge current from the SC output into a load in response to the SC output voltage going above the reference voltage level.
